(19) United States
(12) Patent Application Publication
(10) Pub. No.: US 2024/0110441 A1
(43) Pub. Date: Apr. 4, 2024

(54) PORTABLE ADJUSTABLE SCREENED STRUCTURE

(71) Applicant: Ondray Cleveland, Bronx, NY (US)

(72) Inventor: Ondray Cleveland, Bronx, NY (US)

(21) Appl. No.: 18/191,446

(22) Filed: Mar. 28, 2023

Related U.S. Application Data
(60) Provisional application No. 63/412,035, filed on Sep. 30, 2022.

(51) Int. Cl. E06B 9/52

(52) U.S. Cl. CPC E06B 9/52

(57) ABSTRACT

A screened structure having a plurality of uprights to stake out a surface area. the top elevation of the screened structure being adjustable by the way of telescopic uprights. Between two adjacent uprights a screen curtain and a privacy curtain are slidably attached to a crossbar so that each curtain can move between an open position and a closed position independent of each other. For each span between adjacent uprights, if the screen curtain is in the closed position and the privacy curtain is in the open position air can pass through the mesh of the screen curtain while insects and debris cannot; if both curtains are in their open position the user may egress through that span; or if the privacy curtain is in the closed position there is no visibility therethrough.

### CROSS-REFERENCE TO RELATED APPLICATION

This application claims the benefit of priority of U.S. provisional application No. 63/412,035, filed 30 Sep. 2022, the contents of which are herein incorporated by reference.

### BACKGROUND OF THE INVENTION

The present invention relates to screened structures and more particularly, to a portable, adjustable screened structure.

A screened porch, also known as a screen room, is a type of porch or similar structure on or near the exterior of a residence, adjacent a doorway thereof, wherein the structure is covered by window screens to hinder insects, debris, and other undesirable objects from entering the area inside the screen. Typically created to enhance the livability of a structure that would otherwise be exposed to the annoyances of the outdoors, screened porches often permit residents to enjoy an indoor environment outdoors. These screened structures typically provide a door to the exterior environment.

Without a screened structure, the presence of insects, very common in weather conducive to enjoying an outdoor space, can be a painful annoyance as well as a health hazard.

Unfortunately, such permanent screened structures are expensive to build and likely require obtaining permits that cost additional monies, involve the tangle of red tape, and can take months if not years to obtain.

Moreover, sometime property owners have more than one place near their residence that they would like to enjoy protected by screened walls so even if they had a permanent fixed screened porch, they could not move it to other locations.

A need exists for a portable, adjustable screened structure having two sets of curtains, privacy and screen, which can be selectively moved between an open position and a closed position, independent of each other so as to afford a privacy barrier, a screen barrier or no barrier condition.

### SUMMARY OF THE INVENTION

The portable screened structure is vertically adjustable by way of telescoping uprights.

The portable screened structure provides a plurality of privacy curtains and a plurality of screen curtains, wherein each privacy and screen curtain are selectively and independently movable between an open position and a closed position. When a user moves both the screen and privacy curtains, along a span between the structure's adjustable uprights, to the open or partially open position, then the user may egress to the external environment. When only the screen curtain is in the same span in the closed position, the screen curtain prevents flying insects from entering the space enclosed by the screen structure yet allows for the flow of fresh air from the external environment. When the privacy curtain is in the closed position, it effectively acts as a wall.

Since the present invention is portable, it can be used around different doorways or exterior portions of a residence, depending on which one a person wants to have a screened structure protect. The screened structure can act as a barrier to the door of a residence. The screened structure can act as a movable extension into which the door leads. The screened structure is compatible with different terraces and other places where permanent structures are allowed, especially for renters.

In one aspect of the present invention, a portable screened structure includes the following: a plurality of uprights; a crossbar for each two adjacent uprights of the plurality of uprights; for each crossbar, two slots running parallel along the crossbar for approximately its entire length; and for each crossbar, a screen curtain and a privacy curtain, wherein the screen curtain is slidably engaged in one of the two slots and the privacy curtain is slidably engaged with the other slot so that each curtain moves independently between an open position and a closed position substantially spanning the crossbar.

In another aspect of the present invention, a portable screened structure includes the following: a plurality of uprights, wherein each upright comprising an inner portion telescopically associated with an outer portion so that the inner portion moves relative to the outer portions; a lock knob on each upright for selectively locking the inner portion relative to the outer portion; a crossbar for each two adjacent uprights of the plurality of uprights; for each crossbar, two slots running parallel along the crossbar for approximately its entire length; for each crossbar, a mesh screen curtain and an opaque privacy curtain, wherein the screen curtain is slidably engaged in one of the two slots and the privacy curtain is slidably engaged with the other slot so that each curtain moves independently between an open position and a closed position substantially spanning the crossbar, wherein where in the closed position the mesh screen curtain folds up accordion style; for each curtain having a plurality of C-rings along an upper edge thereof, wherein the slot connector slidably engages one of the two slots; and a reconnectable fastener bisecting at least one privacy curtain for separating said privacy curtain in opposite directions along a shared slot.

These and other features, aspects and advantages of the present invention will become better understood with reference to the following drawings, description, and claims.

### BRIEF DESCRIPTION OF THE DRAWINGS

FIG. 1 is a perspective view of an exemplary embodiment of the present invention, shown with the privacy curtains in the closed position.

FIG. 2 is a perspective view of an exemplary embodiment of the present invention, illustrating the front privacy and screen curtain in the open position and a side privacy curtain folded in the open position, while is partner screen curtain is in the closed position.

FIG. 3 is a detailed exploded perspective view of an exemplary embodiment of the present invention, illustrating the connection of the curtains to the crossbars by way of dual track upon which each curtain independently slides between the open and closed positions.

FIG. 4 is a detailed front elevation view of an exemplary embodiment of the present invention, showing the adjustable motion of the inner uprights for increasing the top elevation of the screen structure.

FIG. 5 is a rear elevation view of an exemplary embodiment of the present invention, illustrating a reconnectable fastener that enables a curtain to separated into two separate portions that can be selectively moved to the open position in opposite directions.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a screened structure having a plurality of uprights to stake out a surface area. the top elevation of the screened structure being adjustable by the way of telescopic uprights. Between two adjacent uprights a screen curtain and a privacy curtain are slidably attached to a crossbar so that each curtain can move between an open position and a closed position independent of each other. For each span between adjacent uprights, if the screen curtain is in the closed position and the privacy curtain is in the open position air can pass through the mesh of the screen curtain while insects and debris cannot; if both curtains are in their open position the user may egress through that span; or if the privacy curtain is in the closed position there is no visibility therethrough.

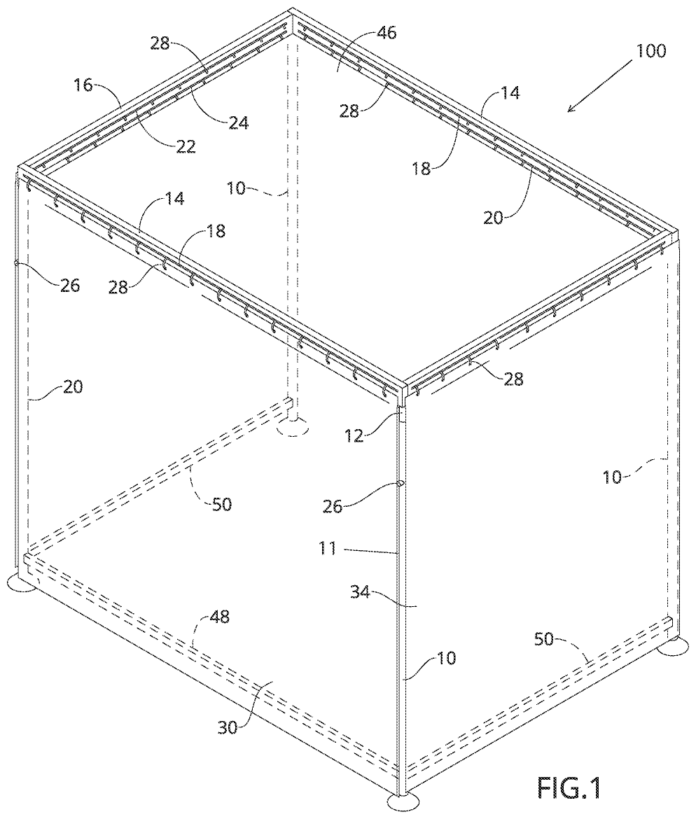

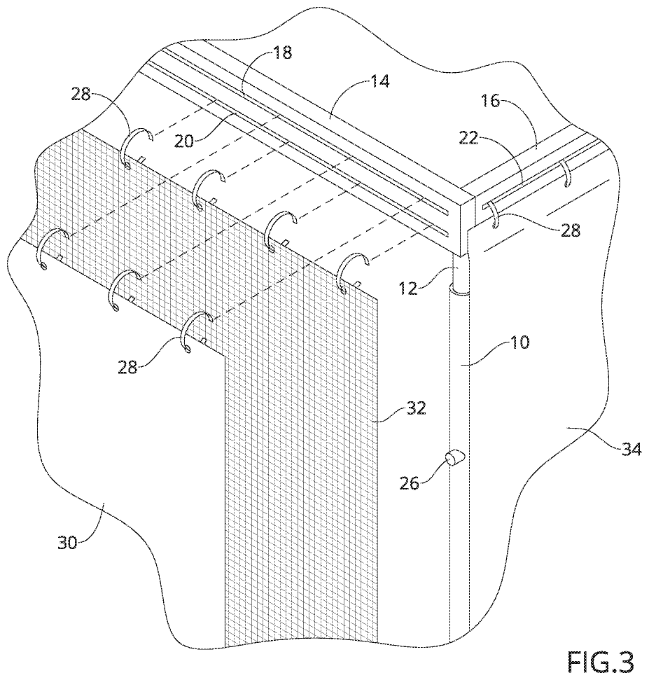

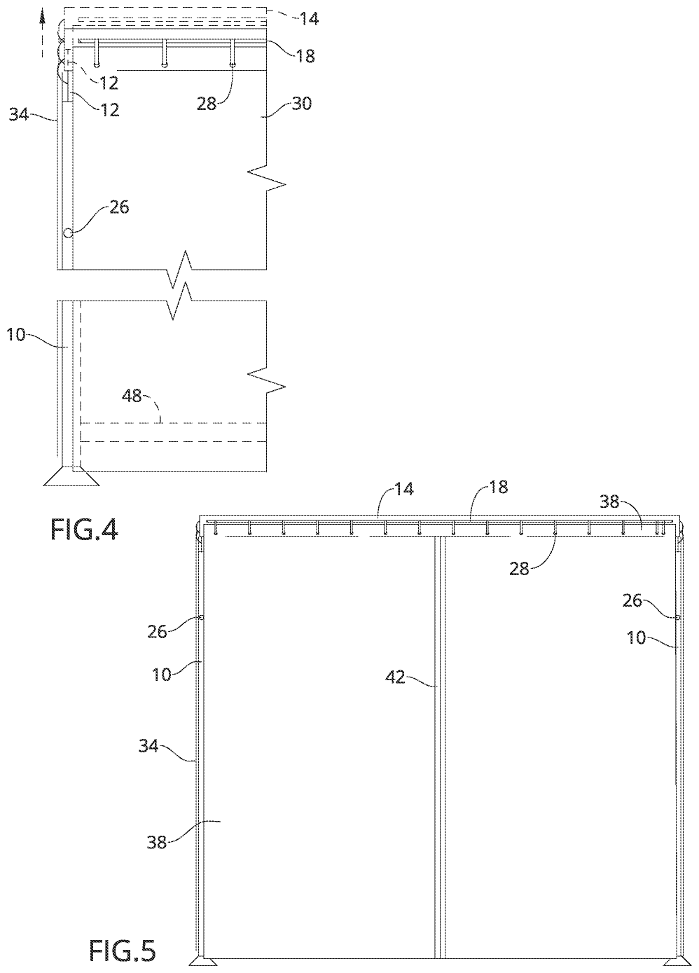

Referring to FIGS. 1 through 5, the present invention may include a screened structure 100 having a plurality of telescopic uprights 11 including an inner portion 12 and an outer portion 10 telescopically associated so that the inner portion 12 can move relative the outer portion 10. Each upright 11 may have an adjustment control 26 for selectively locking the position of the inner portion 12 relative to its operatively associated outer portion 10. Typically, the screened structure 100 may have four uprights 11 to define a rectangular circumscribed space.

Crossbars 14, 16, 48, and 50 may extend between ends of adjacent uprights 11, some from at or near an upper end of the inner portions 12 and others at or near a lower end of the outer portions 10. One or more of the crossbars interconnecting upper ends of the uprights 11 may have dual tracks 18 and 20 or 22 and 24, wherein the two tracks are parallel but vertically spaced apart.

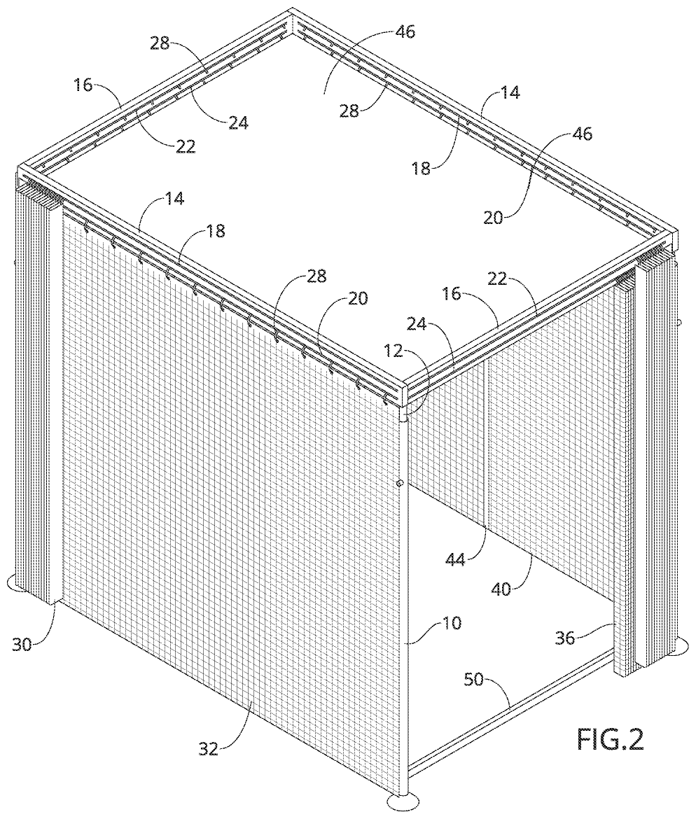

The screened structure 100 may have screen curtains 32, 36, 40 and 42 and privacy curtains 30, 34, and 38 dimensioned to be at least coextensive with an area defined by the open span between adjacent uprights 11. There may be a top screen curtain 46 connected between the upper crossbars in a horizontal plane, as illustrated in FIG. 2. Each curtain may be configured to collapse, fold, or pile-up, as seen on the right-most edge of FIG. 2, accordion style in the closed position.

An upper portion of each curtain may have a track connector 28. The track connector can be any shaped object capable of slidably engaging one of the slots 18, 20, 22, or 24 so that it selectively slides there along carrying a portion of the curtain it is attached to. The track connector 28 may be C-ring or other objects that function as disclosed herein. The separated dual tracks enable a user to selectively move a first curtain in a first track independently of a second curtain operatively associated with the second track. As a result, different curtains along the same crossbar can occupy different open/closed positions. Accordingly, the first curtain may be in the open position while the second curtain is in the closed position or both curtains can be in the one of the open or closed positions.

The privacy curtain may be made of fiberglass, various plasticized material or other synthetic material. A reconnectable fastener 42 and 44, such as a zipper, may vertically oriented near a midportion of a curtain so that two portions thereof can be separated and slid in opposite directions along a shared operatively associated track.

The method of using the present invention may include the following. The screened structure 100 disclosed herein may be provided and placed on a terrace, circumscribing a floor area thereof, adjacent to a door. To stop insects from entering circumscribed space the user would ensure all the screen curtains were in the closed position. To ensure privacy the user would move all the privacy curtains were in the closed position. To step outside of the circumscribed space the user would move the screen and privacy curtains in one span to the open position.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A portable screened structure, comprising:
a plurality of uprights;
a crossbar for each two adjacent uprights of the plurality of uprights;
for each crossbar, two slots running parallel along the crossbar for approximately its entire length; and
for each crossbar, a screen curtain and a privacy curtain, wherein the screen curtain is slidably engaged in one of the two slots and the privacy curtain is slidably engaged with the other slot so that each curtain moves independently between an open position and a closed position substantially spanning the crossbar.

2. The portable screened structure of claim 1, further comprising: for each curtain having a plurality of slot connectors along an upper edge thereof, wherein the slot connector slidably engages one of the two slots.

3. The portable screened structure of claim 1, wherein each upright comprising an inner portion telescopically associated with an outer portion so that the inner portion moves relative to the outer portions.

4. The portable screened structure of claim 3, further comprising a lock knob on each upright for selectively locking the inner portion relative to the outer portion.

5. The portable screened structure of claim 1, further comprising a reconnectable fastener bisecting at least one privacy curtain for separating said privacy curtain in opposite directions along a shared slot.

6. The portable screened structure of claim 1, where in the closed position the screen curtain folds up accordion style.

7. The portable screened structure of claim 1, wherein each screen curtain is made of mesh.

8. The portable screened structure of claim 1, wherein each privacy curtain is opaque.

9. The portable screened structure of claim 2, wherein each slot connector is a C-ring.

10. A portable screened structure, comprising:
a plurality of uprights, wherein each upright comprising an inner portion telescopically associated with an outer portion so that the inner portion moves relative to the outer portions;
a lock knob on each upright for selectively locking the inner portion relative to the outer portion;
a crossbar for each two adjacent uprights of the plurality of uprights;
for each crossbar, two slots running parallel along the crossbar for approximately its entire length;
for each crossbar, a mesh screen curtain and an opaque privacy curtain, wherein the screen curtain is slidably engaged in one of the two slots and the privacy curtain is slidably engaged with the other slot so that each curtain moves independently between an open position and a closed position substantially spanning the crossbar, wherein where in the closed position the mesh screen curtain folds up accordion style;
for each curtain having a plurality of C-rings along an upper edge thereof, wherein the slot connector slidably engages one of the two slots; and
a reconnectable fastener bisecting at least one privacy curtain for separating said privacy curtain in opposite directions along a shared slot.
